(19) United States
(12) Patent Application Publication
(10) Pub. No.: US 2006/0078711 A1
(43) Pub. Date: Apr. 13, 2006

(54) Magnetic recording medium and magnetic recording and reproducing method using the same

(75) Inventors: Toshiharu Takeda, Kanagawa (JP); Youhei Aritoshi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/237,747

(22) Filed: Sep. 29, 2005

(30) Foreign Application Priority Data
Sep. 30, 2004 (JP) P. 2004-288084

(51) Int. Cl. G11B 5/64

(52) U.S. Cl. 428/141

(57) ABSTRACT

A magnetic recording medium comprising: a nonmagnetic support; and a magnetic layer containing ferromagnetic powder and a binder, wherein the magnetic layer has on a surface thereof 80 or less depressions having a depth of 10 nm or more per 260×350 μm².

### FIELD OF THE INVENTION

This invention relates to a magnetic recording medium and a magnetic recording and reproducing method. More particularly, it relates to a magnetic recording medium which involves a minimized spacing loss and thereby exhibits reduced dropout rate and error rate and to a magnetic recording and reproducing method in which information written on the magnetic recording medium is read with a read head utilizing a magneto-resistive (MR) element, called an MR head.

### BACKGROUND OF THE INVENTION

With the increasing capacity of hard disks, data backup tapes for hard disks having a memory capacity of 200 GB or more per tape have been commercialized. Further increase of capacity of backup tapes is indispensable to cope with further increase of storage capacity of hard disks.

The capacity per tape can be increased by reducing the total tape thickness to increase the tape length per cartridge. Another approach is to extremely reduce the magnetic layer thickness to 0.15 μm or smaller to minimize thickness loss and to reduce the track width to 10 μm or smaller while shortening a recording wavelength, thereby to heighten the recording density in the tape width direction.

However, as the recording wavelength is shortened, the influence of the spacing between a magnetic layer and a magnetic head increases. As a result, depressions on a magnetic layer creating a spacing loss would cause widening of the half-value width of output peaks (PW50) or reduction of output, resulting in an increased error rate. Narrowing a track width to 10 μm or less to increase the recording density in the width direction results in a reduction of leakage magnetic flux from the magnetic recording medium, which necessitates use of an MR read head that can provide high output from a small magnetic flux.

For the purpose of eliminating fatal errors leading to real damage which occur in linear serpentine recording using RLL(2,7) as a data modulation method, JP-A-2001-84549 discloses a magnetic recording medium having a support and a magnetic layer containing ferromagnetic powder and a binder as main components. The magnetic layer has not more than 10 depressions with a depth of 50 nm or more in an area of 46237.5 μm² and a maximum depth of depressions of 100 nm or less as measured with a non-contact profilometer.

However, the disclosed magnetic recording medium is disadvantageous in that it has an increased error rate when used in high density (digital) recording at a recording wavelength of 0.3 μm or shorter. As a result of investigations, the present inventors have found that reduction in density of 50 nm or deeper depressions is insufficient and that the density of less deep depressions must be reduced as well in order to suppress dropout. That is, reducing the number of 50 nm or deeper depressions even to zero does not always result in elimination of dropout, and the error rate is still high in the high density recording.

### SUMMARY OF THE INVENTION

An object of the present invention is to provide a magnetic recording medium involving a reduced spacing loss thereby exhibiting reduced dropout and error rates. Another object of the invention is to provide a magnetic recording and reproducing method in which information recorded on the magnetic recording medium is read with an MR head having high reading ability.

The present invention provides a magnetic recording medium comprising a nonmagnetic support and a magnetic layer containing ferromagnetic powder dispersed in a binder on the nonmagnetic support. The magnetic layer has on the surface thereof 80 or fewer depressions having a depth of 10 nm or more per (260×350) μm².

In a preferred embodiment of the magnetic recording medium of the invention, the medium further comprises a nonmagnetic layer having nonmagnetic powder dispersed in a binder between the nonmagnetic support and the magnetic layer.

In another preferred embodiment of the magnetic recording medium of the invention, the magnetic layer has a centerline average surface roughness Ra of 4.5 nm or less.

In still another preferred embodiment of the magnetic recording medium of the invention, the magnetic layer has a thickness of 0.15 μm or smaller.

The present invention also provides a magnetic recording and reproducing method for writing and reading information using a magnetic recording medium comprising a nonmagnetic support and a magnetic layer having ferromagnetic powder dispersed in a binder, wherein the magnetic recording medium is the magnetic recording medium of the present invention, and a magnetic head having an MR element is used for reading the information.

In a preferred embodiment of the magnetic recording and reproducing method of the invention, the recording wavelength is 0.3 μm or shorter.

By specifying the density of depressions on the magnetic layer surface taking a depth of 10 nm, the present invention provides a magnetic recording medium having a reduced spacing loss, reduced dropout, and a reduced error rate and a magnetic recording and reproducing method in which information recorded on the magnetic recording medium is read using an MR head having high reading ability.

### DETAILED DESCRIPTION OF THE INVENTION

The magnetic recording medium of the present invention has a nonmagnetic support having provided thereon at least a magnetic layer having ferromagnetic powder dispersed in a binder. It is essential that the number of 10 nm or deeper depressions present on the surface of the magnetic layer be 80 or fewer in an area of (260×350) μm². The number of 10 nm or deeper depressions in an area of (260×350) μm² is referred to simply as a depression density. The depression density is preferably 1 to 70 per (260×350) μm², still preferably 1 to 50 per (260×350) μm².

The depression density is measured with a commercially available 3D surface profilometer. In the present invention, the inventors used a three-dimensional imaging surface structure analyzer, New View 5022 from ZyGo Corp. that operates using scanning white light interferometry. The scan length was 5 μm, and the assessment area was 260 μm by 360 μm. Measurement was taken on 10 different assessment areas. The data were processed by HPF (high pass filtering) at a wavelength of 1.65 μm and LPF (low pass filtering) at a wavelength of 50 μm. Valleys having a depth of 10 nm or more from a mean plane of the resulting surface profile were counted for every assessment area to obtain an average. The terminology “mean plane” means a reference plane for which the volumes embraced by the 3D profile above and below the plane are equal.

The depression density can be controlled within the recited range by, for example, adjusting the surface hardness of the magnetic layer so that the surface profile of the back side of the magnetic recording medium may be prevented from being impressed onto the magnetic layer while the magnetic recording medium is in a roll form. The surface hardness of the magnetic layer can be controlled by selecting the kinds and the amounts of binders (binder formulation) used therein. It is also controllable by the conditions of coating or calendering. An illustrative example of how to control the magnetic layer hardness by the binder formulation is shown below.

Suitable binders include polyurethane resins having a bridged hydrocarbon structure or a spiro structure. The polyurethane resins are not only advantageous for depression density control but also beneficial from various aspects as will be understood from the following description.

The term “bridged hydrocarbon structure” denotes an aliphatic hydrocarbon skeleton having at least two rings sharing two or more atoms. The term “spiro structure” means at least two rings sharing one atom. The polyurethane resin having a bridged hydrocarbon structure or a spiro structure is preferably a polyurethane resin having at least one of a bridge hydrocarbon structure represented by formula (1), a bridge hydrocarbon structure represented by formula (2), and a spiro structure represented by formula (3):

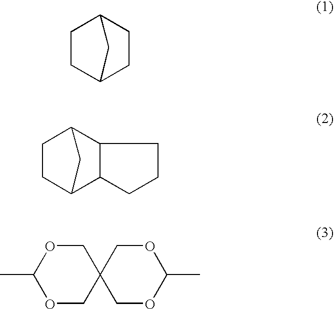

The bridged hydrocarbon structure or the spiro structure can be introduced from a diol component as a polyol component, a short-chain diol component acting as a chain extender, and an organic diisocyanate component.

A polyol component having the bridged hydrocarbon structure or the spiro structure includes polyester polyols, polyether polyols, and polycarbonate polyols prepared using a short chain diol having the bridged hydrocarbon structure or the spiro structure.

Examples of the short chain diols having the bridged hydrocarbon structure include bicyclo[1.1.0]butanediol, bicyclo[1.1.1]pentanediol, bicyclo[2.1.0]pentanediol, bicyclo[2.1.1]hexanediol, bicyclo[3.1.0]hexanediol, bicyclo[2.2.1]heptanediol, bicyclo[3.2.0]heptanediol, bicyclo[3.1.1]heptanediol, bicyclo[2.2.2]octanediol, bicyclo[3.2.1]octanediol, bicyclo[4.2.0]octanediol, bicyclo[5.2.0]nonanediol, bicyclo[3.3.1]nonanediol, bicyclo[3.3.2]decanediol, bicyclo[4.2.2]decanediol, bicyclo[4.3.3]dodecanediol, bicyclo[3.3.3]undecanediol, bicyclo[1.1.0]butanedimethanol, bicyclo[1.1.1]pentanedimethanol, bicyclo[2.1.0]pentanedimethanol, bicyclo[2.1.1]hexanedimethanol, bicyclo[3.1.0]hexanedimethanol, bicyclo[2.2.1]heptanedimethanol, bicyclo[3.2.0]heptanedimethanol, bicyclo[3.1.1]heptanedimethanol, bicyclo[2.2.2]octanedimethanol, bicyclo[3.2.1]octanedimethanol, bicyclo[4.2.0]octanedimethanol, bicyclo[5.2.0]nonanedimethanol, bicyclo[3.3.1]nonanedimethanol, bicyclo[3.3.2]decanedimethanol, bicyclo[4.2.2]decanedimethanol, bicyclo[4.3.3]dodecanedimethanol, bicyclo[3.3.3]undecanedimethanol, tricyclo[2.2.1.0]heptanediol, tricyclo[5.2.1.0^{2,6}]decanediol, tricyclo[4.2.1.2^{7,9}]undecanediol, tricyclo[5.4.0.0^{2,9}]undecanediol, tricyclo[5.3.1.1]dodecanediol, tricyclo[4.4.1.1]dodecanediol, tricyclo[7.3.2.0^{5,13}]tetradecanediol, tricyclo[5.5.1.0^{3,11}]tridecanediol, tricyclo[2.2.1.0]heptanedimethanol, tricyclo[5.2.1.0^{2,6}]decanedimethanol, tricyclo[4.2.1.2^{7,9}]undecanedimethanol, tricyclo[5.4.0.0^{2,9}]undecanedimethanol, tricyclo[5.3.1.1]dodecanedimethanol, tricyclo[4.4.1.1]dodecanedimethanol, tricyclo[7.3.2.0^{5,13}]tetradecanedimethanol, and tricyclo[5.5.1.0^{3,11}]tridecanedimethanol.

Examples of the short chain diols having the spiro structure include spiro[3,4]octanedimethanol, spiro[3,4]heptanedimethanol, spiro[3,4]decanedimethanol, dispiro[5,1,7,2]heptadecanedimethanol, cyclopentanespirocyclobutanedimethanol, cyclohexanespirocyclopentanedimethanol, spirobicyclohexanedimethanol, and bis(1,1-dimethyl-2-hydroxyethyl)-2,4,8,10-tetraoxaspiro[5,5]undecane. Preferred of them is bis(1,1-dimethyl-2-hydroxyethyl)-2,4,8,10-tetraoxaspiro[5,5]undecane.

The polyol component having the bridged hydrocarbon structure or the spiro structure preferably includes a polyester polyol derived from tricyclo[5.2.1.0^{2,6}]decanedimethanol, a polyether polyol of a propylene oxide adduct of tricyclo[5.2.1.0^{2,6}]decanedimethanol, and a polycarbonate polyol derived from tricyclo[5.2.1.0^{2,6}]decanedimethanol.

Known dibasic acids can be used to prepare the polyester polyols. Examples are isophthalic acid, terephthalic acid, naphthalenedicarboxylic acid, succinic acid, adipic acid, azelaic acid, sebacic acid, malonic acid, glutaric acid, pimelic acid, and suberic acid. Preferred of them are succinic acid, adipic acid, and sebacic acid.

The polyether polyols and the polycarbonate polyols may contain a known short chain diol component in addition to the above-described short chain diol having the bridged hydrocarbon structure or the spiro structure. Examples of the other useful short chain diol monomers include aliphatic straight-chain diols, such as 1,3-propanediol, 1,4-butanediol, 1,5-pentanediol, and 1,6-hexanediol; aliphatic diols having a branched side chain, such as 2,2-dimethyl-1,3-propanediol, 3,3-dimethyl-1,5-pentanediol, 2-methyl-2-ethyl-1,3-propanediol, 3-methyl-3-ethyl-1,5-pentanediol, 2-methyl-2-propyl-1,3-propanediol, 3-methyl-3-propyl-1,5-pentanediol, 2-methyl-2-butyl-1,3-propanediol, 3-methyl-3-butyl-1,5-pentanediol, 2,2-diethyl-1,3-propanediol, 3,3-diethyl-1,5-pentanediol, 2-ethyl-2-butyl-1,3-propanediol, 3-ethyl-3-butyl-1,5-pentanediol, 2-ethyl-2-propyl-1,3-propanediol, 3-ethyl-3-propyl-1,5-pentanediol, 2,2-dibutyl-1,3-propanediol, 3,3-dibutyl-1,5-pentanediol, 2,2-dipropyl-1,3-propanediol, 3,3-dipropyl-1,5-pentanediol, 2-butyl-2-propyl-1,3-propanediol, 3-butyl-3-propyl-1,5-pentanediol, 2-ethyl-1,3-propanediol, 2-propyl-1,3-propanediol, 2-butyl-1,3-propanediol, 3-ethyl-1,5-pentanediol, 3-propyl-1,5-pentanediol, 3-butyl-1,5-pentanediol, 3-octyl-1,5-pentanediol, 3-myristyl-1,5-pentanediol, 3-stearyl-1,5-pentanediol, 2-ethyl-1,6-hexanediol, 2-propyl-1,6-hexanediol, 2-butyl-1,6-hexanediol, 5-ethyl-1,9-nonanediol, 5-propyl-1,9-nonanediol, and 5-butyl-1,9-nonanediol; and diols having a cyclic structure, such as bisphenol A and hydrogenated bisphenol A.

The aforementioned short chain diol having the bridged hydrocarbon structure or the spiro structure may be used as a chain extender. Examples of the short chain diol having the bridged hydrocarbon structure or the spiro structure that are suited for use as a chain extender are tricyclo[2.2.1.0]heptanedimethanol, tricyclo[5.2.1.0^{2,6}]decanedimethanol, bicyclo[3.3.2]decanedimethanol, bicyclo[4.2.2]decanedimethanol, spiro[3,4]decanedimethanol, and bis(1,1-dimethyl-2-hydroxyethyl)-2,4,8,10-tetraoxaspiro[5,5]undecane. Tricyclo[5.2.1.0^{2,6}]decanedimethanol and bis(1,1-dimethyl-2-hydroxyethyl)-2,4,8,10-tetraoxaspiro[5.5]undecane are particularly preferred.

Diisocyanate compounds having the bridged hydrocarbon structure or the Spiro structure include tricyclo[2.2.1.0]heptane diisocyanate, tricyclo[5.2.1.0^{2,6}]decane diisocyanate, tricyclo[4.2.1.2^{7,9}]undecane diisocyanate, tricyclo[5.4.0.0^{2,9}]undecane diisocyanate, tricyclo[5.3.1.1]dodecane diisocyanate, tricyclo[4.4.1.1]dodecane diisocyanate, tricyclo[7.3.2.0^{5,13}]tetradecane diisocyanate, tricyclo[5.5.1.0^{3,11}]tridecane diisocyanate, norbornene diisocyanate, spiro[3,4]octane diisocyanate, spiro[3,4]heptane diisocyanate, spiro[3,4]decane diisocyanate, dispiro[5,1,7,2]heptadecane diisocyanate, cyclopentanespirocyclobutane diisocyanate, cyclohexanespirocyclopentane diisocyanate, and spirobicyclohexane diisocyanate. Preferred of them are tricyclo[5.2.1.0^{2,6}]decane diisocyanate and norbornene diisocyanate.

Diisocyanate components that can be used in combination with the above-described polyol and short chain diol components having the bridged hydrocarbon structure or the spiro structure is selected from among known compounds. Examples of suitable diisocyanate compounds include tolylene diisocyanate (TDI), diphenylmethanediisocyanate (MDI), p-phenylenediisocyanate, o-phenylene diisocyanate, m-phenylene diisocyanate, xylylene diisocyanate, hydrogenated xylylene diisocyanate, and isophorone diisocyanate.

To secure durability and surface smoothness of the magnetic layer, the content of the bridged hydrocarbon structure or the spiro structure in the polyurethane resin is preferably 1 to 5.5 mmol/g.

The polyurethane resin preferably has a urethane group content of 2.0 to 6.0 mmol/g, still preferably 2.5 to 5.5 mmol/g. Within that range of a urethane group content, the glass transition temperature (Tg) of the coating layer is high enough to secure durability, and solvent solubility is secured to maintain dispersing capabilities. With the dispersing capabilities maintained, polyol can be incorporated to control the molecular weight easily, which offers advantage in the synthesis.

The polyurethane resin preferably has a weight average molecular weight of 40,000 to 100,000, still preferably 50,000 to 90,000, so as to secure both coating film strength, which provides satisfactory durability, and solvent solubility, which provides satisfactory dispersing capabilities.

The Tg of the polyurethane resin is preferably 40° to 200° C., still preferably 70° to 180°, even still preferably 80° to 170° C. Within that range, the coating film exhibits strength even in high temperatures to secure durability and storage stability and also shows good callenderability and satisfactory electromagnetic characteristics.

The polyurethane resin may contain a polar group. Preferred polar groups include —SO₃M, —OSO₃M, —PO₃M₂, and —COOM, where M is a hydrogen atom, an alkali metal or an ammonium group, with —SO₃M and —OSO₃M being still preferred. A preferred polar group content in the polyurethane resin is 1×10⁻⁵ eq/g to 5×10⁻⁴ eq/g. Within that range, the polyurethane resin exhibits sufficient adsorption to magnetic powder and sufficient solubility in a solvent to secure powder dispersing capabilities.

The polyurethane resin may contain a hydroxyl group. The number of hydroxyl groups per molecule of the polyurethane resin is preferably 2 to 20, still preferably 3 to 15. Polyurethane resin containing fewer than 2 hydroxyl groups per molecule has reduced reactivity with the isocyanate curing agent to provide a cured film insufficient in film strength and durability. Polyurethane resin containing more than 20 hydroxyl groups per molecule tends to have reduced solvent solubility and reduced dispersing ability.

The polyurethane resin may be used in combination with other known binders, such as thermoplastic resins, thermosetting resins, reactive resins, and mixtures thereof. The binders are suitably used in a total amount of 5% to 50% by weight, preferably 8% to 40% by weight, still preferably 10% to 30% by weight, based on the ferromagnetic powder. A recommended proportion of the aforementioned polyurethane resin in the binder formulation is 30% to 100% by weight, preferably 50% to 100% by weight, still preferably 70% to 100% by weight.

The ferromagnetic powder that can be used to form the magnetic layer is appropriately selected from among known ones. It is particularly preferred to use acicular ferromagnetic powder having a length of 20 to 100 nm or tabular magnetic particles having a diameter of 10 to 50 nm.

The acicular ferromagnetic powder preferably used in the invention is a ferromagnetic Co-doped iron oxide powder or a ferromagnetic alloy powder. The acicular particles have a BET specific surface area (S_{BET}) of 40 to 80 m²/m, preferably 50 to 70 m²/g, a crystallite size of 5 to 25 nm, preferably 8 to 22 nm, still preferably 10 to 20 nm, a length of 20 to 100 nm, preferably 20 to 70 nm, still preferably 20 to 50 nm.

The acicular ferromagnetic powder includes yttrium-containing Fe, Fe—Co, Fe—Ni, and Co—Ni—Fe. A preferred yttrium content is 0.5 to 20 at %, still preferably 5 to 10 at %, based on Fe. With a yttrium content less than 0.5 at %, high saturation magnetization is not achieved, resulting in reduced magnetic characteristics, which leads to reduced electromagnetic characteristics. With a yttrium content more than 20 at %, the Fe content decreases to reduce the magnetic characteristics, resulting in reduced electromagnetic characteristics. The ferromagnetic powder may further contain up to 20 at %, based on Fe atom, of aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. The acicular ferromagnetic powder may contain a small amount of water, a hydroxide or an oxide.

An illustrative example of the preparation of a Co- and Y-doped, acicular ferromagnetic powder is given below.

In this example an iron oxyhydroxide obtained by bubbling oxidizing gas through an aqueous suspension containing an iron (II) salt and an alkali is used as a starting material. The iron oxyhydroxide is preferably α-FeOOH. There are two processes of preparing α-FeOOH. In a first process an iron (II) salt is neutralized with an alkali hydroxide to obtain an aqueous suspension of Fe(OH)₂, which is oxidized by bubbling oxidizing gas to obtain acicular α-FeOOH. In a second process an iron (II) salt is neutralized with an alkali carbonate to obtain an aqueous suspension of FeCO₃, which is oxidized by bubbling oxidizing gas to obtain spindle-shaped α-FeOOH. The iron oxyhydroxide is preferably obtained by allowing an aqueous solution of an iron (II) salt and an alkali aqueous solution to react to obtain an aqueous solution containing iron (II) hydroxide, which is then oxidized with air, etc. To the iron (II) salt aqueous solution may be added a salt properly selected from a nickel salt, an alkaline earth metal (e.g., Ca, Ba or Sr) salt, a chromium salt, a zinc salt, etc. to adjust the particle shape such as an axial ratio.

The iron (II) salt preferably includes iron (II) chloride and iron (II) sulfate. The alkali preferably includes sodium hydroxide, aqueous ammonia, ammonium carbonate, and sodium carbonate. The salt that can be added to the reaction system is preferably a chloride, such as nickel chloride, calcium chloride, barium chloride, strontium chloride, chromium chloride or zinc chloride.

Where iron is doped with cobalt, an aqueous solution of a cobalt compound, e.g., cobalt sulfate or cobalt chloride, is mixed into the iron oxyhydroxide suspension by stirring to prepare an iron oxyhydroxide suspension containing cobalt. A yttrium is then introduced by mixing an aqueous solution of a yttrium compound into the Co-containing suspension by stirring.

In addition to yttrium, neodymium, samarium, praseodymium, lanthanum, etc. may be introduced into the acicular ferromagnetic powder. Examples of compounds used therefor include chlorides, such as yttrium chloride, neodymium chloride, samarium chloride, praseodymium chloride, and lanthanum chloride, and nitrates, such as neodymium nitrate and gadolinium nitrate. These dopiness can be used either individually or as a combination of two or more thereof.

The acicular ferromagnetic powder preferably has a coercive force (Hc) of 159.2 to 238.8 kA/m (2,000 to 3,000 Oe), still preferably 167.2 to 230.8 kA/m (2,100 to 2,900 Oe), and a saturation magnetization (σs) of 80 to 170 A·m²/kg (80 to 170 emu/g), still preferably 100 to 130 A·m²/kg (100 to 130 emu/g).

The switching field distribution (SFD) of the acicular ferromagnetic powder itself is preferably as small as possible, specifically 0.8 or smaller. A magnetic medium having a small SFD exhibits satisfactory electromagnetic characteristics, high output, and sharp magnetization reversal with a small peak shift, which is advantageous for high-density digital magnetic recording. The coercivity distribution can be narrowed by, for example, using goethite with a narrow size distribution, using mono-dispersed α-Fe₂O₃ particles, or preventing sintering of particles.

The tabular magnetic powder that can be used in the invention, preferably has a diameter of 10 to 50 nm. The tabular magnetic powder is preferably a hexagonal ferrite powder. The hexagonal ferrite powder includes barium ferrite, strontium ferrite, lead ferrite, and calcium ferrite, and their substituted compounds, and Co-doped compounds thereof. Specific examples are barium ferrite and strontium ferrite of magnetoplumbite type; magnetoplumbite type ferrites coated with spinel; and barium ferrite and strontium ferrite of magnetoplumbite type containing a spinel phase in parts. These ferrites may contain additional elements, such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, and Nb. Usually, ferrites doped with Co—Ti, Co—Ti—Zr, Co—Ti—Zn, Ni—Ti—Zn, Nb—Zn—Co, Sb—Zn—Co, Nb—Zn, etc. can be used. The ferrites may contain impurities specific to the starting material or the process of preparation.

The tabular magnetic powder has a diameter of 10 to 50 nm, preferably 15 to 45 nm, still preferably 20 to 35 nm. Where the recording medium is reproduced with an MR head, the diameter is preferably 40 nm or smaller for the necessity to reduce noise. Within the above range, stable magnetization is promised without involving thermal fluctuation, and noise is low to allow for high density magnetic recording.

The tabular magnetic powder preferably has an aspect ratio (diameter to thickness ratio) of 1 to 15, still preferably 2 to 7. Within the above range, the tabular particles exhibit sufficient orientation properties, hardly stack on each other, and have reduced noise. Tabular magnetic powder having the recited particle size has an S_{BET} of 10 to 200 m²/g. The specific surface area approximately agrees with the value calculated from the diameter and the thickness. The crystallite size is 5 to 45 nm, preferably 10 to 35 nm. The narrower the size (diameter and thickness) distribution, the better. Although it is difficult to quantify the diameter and thickness distribution, comparison can be made by measuring the size of randomly chosen 500 particles of a transmission electron micrograph of powder. While the distribution is often not normal, calculations give a standard deviation (a) to mean size ratio of 0.1 to 2.0. To narrow the particle size distribution, the reaction system for particle formation is made as uniform as possible, and a distribution improving treatment may be added to the resulting particles, such as selective dissolution of ultrafine particles in an acid solution.

The tabular magnetic powder can be designed to have a coercive force Hc of about 39.8 to 398 kA/m (500 to 5,000 Oe). Although a higher Hc is more advantageous for high density recording, the Hc is limited by the write head ability. A generally used range is from about 63.7 to 318.4 kA/m (800 to 4,000 Oe), preferably 119.4 to 278.6 kA/m (1,500 to 3,500 Oe). When the saturation magnetization of a head exceeds 1.4 T, the Hc is preferably 159.2 kA/m (2,000 Oe) or higher.

Hc is controllable by the particle size (diameter and thickness), the kinds and amounts of constituent elements, the site of substitution by the dopant element, reaction conditions of particle formation, and so on. The saturation magnetization as is 40 to 80 A·m²/kg (40 to 80 emu/g). While a higher as is more advantageous, a saturation magnetization tends to decrease as the particle size becomes smaller. It is well known that the saturation magnetization can be improved by using a magnetoplumbite type ferrite combined with a spinel type ferrite or by properly selecting the kinds and amounts of constituent elements. It is also possible to use a wurtzite type hexagonal ferrite powder.

For the purpose of improving dispersibility, it is practiced to treat the tabular magnetic powder with a substance compatible with a dispersing medium or the binder resin. The surface treating substance includes organic or inorganic compounds. Typical examples are an oxide or a hydroxide of Si, Al or P, silane coupling agents, and titanium coupling agents. The surface treating substance is usually used in an amount of 0.1% to 10% by weight based on the magnetic powder. The pH of the powder is of importance for dispersibility. The pH usually ranges from about 4 to 12. From the standpoint of chemical stability and storage stability of the magnetic recording medium, a pH of about 6 to 11 is recommended while the optimal p value depends on the dispersing medium or the binder resin to be used. The water content of the powder is also influential on dispersibility. While varying according to the kinds of the dispersing medium or the binder resin, the optimal water content usually ranges from 0.01% to 2.0% by weight.

The process of preparing hexagonal ferrite powder to be used in the invention includes, but is not limited to, (i) a glass crystallization method including the steps of blending barium oxide, iron oxide, an oxide of a metal that is to substitute iron, and a glass forming oxide (e.g., boron oxide) in a ratio providing a desired ferrite composition, melting the blend, rapidly cooling the melt into an amorphous solid, re-heating the solid, washing and grinding the solid to obtain a barium ferrite crystal powder, (ii) a hydrothermal method including the steps of neutralizing a solution of barium ferrite-forming metal salts with an alkali, removing by-products, heating in a liquid phase at 100° C. or higher, washing, drying, and grinding to obtain a barium ferrite crystal powder, and (iii) a coprecipitation method including the steps of neutralizing a solution of barium ferrite-forming metal salts with an alkali, removing by-products, drying, treating at 1100° C. or lower, and grinding to obtain a barium ferrite crystal powder.

If desired, the magnetic layer can contain additives, such as abrasives, lubricants, dispersing agents or dispersing aids, antifungals, antistatics, antioxidants, solvents, and carbon black. Such additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polyolefins, polyglycols, polyphenyl ethers; aromatic ring-containing organic phosphonic acids, such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids, such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphoric acid esters, such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates, such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; alkylsulfonic esters and alkali metal salts thereof; fluorine-containing alkylsulfuric esters and alkali metal salts thereof; monobasic fatty acids having 10 to 24 carbon atoms, either saturated or unsaturated and straight chain or branched, such as lauric acid, myristic acid, palmitic acid, stearic acid, behenic acid, oleic acid, linoleic acid, linolenic acid, elaidic acid, and erucic acid, and metal salts thereof; mono-, di- or higher esters of fatty acids prepared from monobasic fatty acids having 10 to 24 carbon atoms, either saturated or unsaturated and straight-chain or branched, and mono- to hexahydric alcohols having 2 to 22 carbon atoms (either saturated or unsaturated and straight-chain or branched), alkoxyalcohols having 12 to 22 carbon atoms (either saturated or unsaturated and straight-chain or branched) or monoalkyl ethers of alkylene oxide polymers, such as butyl stearate, octyl stearate, amyl stearate, isooctyl stearate, octyl myristate, butyl laurate, butoxyethyl stearate, anhydrosorbitol monostearate, anhydrosorbitol distearate, and anhydrosorbitol tristearate; aliphatic acid amides having 2 to 22 carbon atoms; and aliphatic amines having 8 to 22 carbon atoms. The alkyl, aryl or aralkyl moiety of the above-recited additive compounds may be substituted with a nitro group, a halogen atom (e.g., F, Cl or Br), a halogenated hydrocarbon group (e.g., CF₃, CCl₃ or CBr₃) or a like substituent.

The magnetic layer can also contain surface active agents. Suitable surface active agents include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group or a sulfuric ester group; and amphoteric ones, such as amino acids, aminosulfonic acids, amino alcohol sulfuric or phosphoric esters, and alkyl betaines. For the details of the surface active agents, refer to Kaimen Kasseizai Binran published by Sangyo Tosho K.K.

The above-recited dispersing agents, lubricants, and like additives do not always need to be 100% pure and may contain impurities, such as isomers, unreacted materials, by-products, decomposition products, and oxides. The proportion of the impurities is preferably 30% by weight at the most, still preferably 10% by weight or less.

Specific examples of the additives are NAA-102, hardened castor oil fatty acids, NAA-42, Cation SA, Nymeen L-201, Nonion E-208, Anon BF, and Anon LG from NOF Corp.; FAL 205 and FAL 123 from Takemoto Yushi K.K.; Enujelv OL from New Japan Chemical Co., Ltd.; TA-3 from Shin-Etsu Chemical Industry Co., Ltd.; Armid P from Lion Armour Co., Ltd.; Duomeen TDO from Lion Corp.; BA 41G from Nisshin Oil Mills, Ltd.; Profan 2012E, Newpol PE 61, and Ionet MS400 from Sanyo Chemical Industries, Ltd.

Organic solvents known in the art can be used in the preparation of the coating compositions, including ketones, such as methyl ethyl ketone, methyl isobutyl ketone, diisobutyl ketone, cyclohexanone, isophorone, and tetrahydrofuran; alcohols, such as methanol, ethanol, propanol, butanol, isobutyl alcohol, isopropyl alcohol, and methylcyclohexanol; esters, such as methyl acetate, butyl acetate, isobutyl acetate, isopropyl acetate, ethyl lactate, and glycol acetate; glycol ethers, such as glycol dimethyl ether, glycol monoethyl ether, and dioxane; aromatic hydrocarbons, such as benzene, toluene, xylene, cresol, and chlorobenzene; chlorinated hydrocarbons, such as methylene chloride, ethylene chloride, carbon tetrachloride, chloroform, ethylenechlorohydrin, and dichlorobenzene; N,N-dimethylformamide; and hexane. They can be used as a mixture thereof at an arbitrary mixing ratio.

These organic solvents do not always need to be 100% pure and may contain impurities, such as isomers, unreacted matter, by-products, decomposition products, oxidation products, and water. The impurity content is preferably 30% or less by weight, still preferably 10% or less by weight. The organic solvent used in the formation of the magnetic layer and that used in the formation of the nonmagnetic layer (described below) are preferably the same in kind but may be different in amount. It is advisable to use a solvent with high surface tension (e.g., cyclohexanone or dioxane) in the nonmagnetic layer to improve coating stability. Specifically, it is important that the arithmetic mean of the solvent composition of the upper magnetic layer be equal to or higher than that of the lower nonmagnetic layer. A solvent with somewhat high polarity is preferred for improving dispersing capabilities for powders. The solvent composition preferably contains at least 50% by weight of a solvent having a dielectric constant of 15 or higher. The solubility parameter of the solvent or the solvent system is preferably 8 to 11.

The kinds and amounts of the above-described dispersing agents, lubricants or surface active agents to be used can be decided as appropriate to the type of the layer to which they are added. The following is a few illustrative examples of manipulations using these additives. (i) A dispersing agent has a property of being adsorbed or bonded to fine solid particles via its polar groups. It is adsorbed or bonded via the polar groups mostly to the surface of ferromagnetic powder when used in a magnetic layer or the surface of nonmagnetic powder in a nonmagnetic layer. It is assumed that, after once being absorbed to metal or metal compound particles, an organophosphorus compound, for instance, is hardly desorbed therefrom. As a result, the ferromagnetic powder or nonmagnetic powder treated with a dispersing agent appears to be covered with an alkyl group, an aromatic group or the like, which makes the particles more compatible with a binder resin component and more stable in their dispersed state. (ii) Since lubricants exist in a free state, bleeding of lubricants is controlled by using fatty acids having different melting points between the magnetic layer and the nonmagnetic layer or by using esters different in boiling point or polarity between the magnetic layer and the nonmagnetic layer. (iii) Coating stability is improved by adjusting the amount of a surface active agent. (iv) The amount of the lubricant in the nonmagnetic layer is increased to improve the lubricating effect.

All or part of the additives can be added at any stage of preparing the magnetic or nonmagnetic coating composition. For example, the additives can be blended with the magnetic powder before kneading, or be mixed with the magnetic powder, the binder, and a solvent in the step of kneading, or be added during or after the step of dispersing or immediately before coating.

Carbon blacks that can be used in the magnetic layer include furnace black for rubber, thermal black for rubber, carbon black for color, and acetylene black. The physical properties (hereinafter described) of the carbon black to be used in the magnetic layer should be optimized as appropriate for the effect desired. In some cases, a combined use of carbon black of different species produce better results.

The carbon black has a specific surface area of 100 to 500 m²/g, preferably 150 to 400 m²/g, an oil (DBT) absorption of 20 to 400 ml/100 g, preferably 30 to 200 ml/100 g, an average particle size of 5 to 80 μm, preferably 10 to 50 μm, still preferably 10 to 40 μm, a pH of 2 to 10, a water content of 0.1% to 10% by weight, and a tap density of 0.1 to 1 g/ml.

Examples of commercially available carbon black products that can be used in the magnetic layer include Black Pearls 2000, 1300, 1000, 900, 905, 800, 880, and 700 and Vulcan XC-72 from Cabot Corp.; #3050B, #3150B, #3250B, #3750B, #3950B, #950, #650B, #970B, #850B, MA-600, MA-230, #4000, and #3010 from Mitsubishi Chemical Corp.; Conductex SC, RAVEN 8800, 8000, 7000, 5750, 5250, 3500, 2100, 2000, 1800, 1500, 1255, and 1250 from Columbian Carbon; and Ketjen Black EC from Akzo Nobel Chemicals.

Carbon black having been surface treated with a dispersant, etc., resin-grafted carbon black, or carbon black with its surface partially graphitized may be used. Carbon black may previously been dispersed in a binder before being added to a coating composition. In selecting carbon black species for use, reference can be made, e.g., to Carbon Black Kyokai (ed.), Carbon Black Binran.

The above-enumerated carbon black species can be used either individually or as a combination thereof. The carbon black can be used in an amount of 0.1% to 30% by weight based on the magnetic powder. Carbon black serves for antistatic control, reduction of frictional coefficient, reduction of light transmission, film strength enhancement, and the like. These functions depend on the species. Accordingly, it is understandably possible, or rather desirable, to optimize the kinds, amounts, and combinations of the carbon black species for each layer according to the intended purpose with reference to the above-mentioned characteristics, such as particle size, oil absorption, conductivity, pH, and so forth.

The thickness of the magnetic layer is suitably 0.15 μm or smaller, preferably 0.03 to 0.13 μm, still preferably 0.05 to 0.12 μm, taking application to high density recording into consideration.

The magnetic layer preferably has a centerline average surface roughness Ra of 4.5 nm or smaller, still preferably 3.0 nm or smaller. If Ra exceeds 4.5 nm, electromagnetic characteristics are deteriorated in recording at a recording wavelength of 0.3 μm or shorter. The Ra of the magnetic layer is controllable through various means. For example, a desired Ra is obtained by controlling or selecting the surface roughness of the support, the thickness of the coating layer, the particle size of the powder used in the coating layer, and the surface treating conditions (such as the linear pressure and the roll surface conditions in calendering).

In the present invention the parameter “Ra” is defined to be a value measured with a three-dimensional imaging surface structure analyzer, New View 5022 from ZyGo Corp. that operates using scanning white light interferometry. The scan length was 5 μm, and the assessment area was 260 μm by 360 μm. The data were processed by HPF at a wavelength of 1.65 μm and LPF at a wavelength of 50 μm. Measurement was taken on 10 different assessment areas to obtain an average.

The magnetic recording medium of the invention may have at least one nonmagnetic layer having nonmagnetic powder dispersed in a binder between the nonmagnetic support and the magnetic layer. The binder of the nonmagnetic layer is preferably the same as that used in the magnetic layer. The nonmagnetic powder may be either organic or inorganic. If desired, the nonmagnetic layer may contain carbon black in addition to the nonmagnetic powder.

The nonmagnetic layer is allowed to contain magnetic powder as long as the layer is substantially nonmagnetic. To use nonmagnetic powder is preferred nevertheless.

The nonmagnetic powder may be of either organic or inorganic materials. Carbon black may also be used. The inorganic nonmagnetic materials include metals, metal oxides, metal carbonates, metal sulfates, metal nitrides, metal carbides, and metal sulfides. Examples of the inorganic nonmagnetic materials are titanium oxides (e.g., titanium dioxide), cerium oxide, tin oxide, tungsten oxide, ZnO, ZrO₂, SiO₂, Cr₂O₃, α-alumina having an α-phase content of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide. They can be used either individually or in combination. Preferred among them are α-iron oxide and titanium oxide.

The shape of the nonmagnetic powder particles may be any of acicular, spherical, polygonal and tabular shapes. The crystallite size of the nonmagnetic powder is preferably 4 nm to 1 μm, still preferably 40 to 100 nm. Particles with the crystallite size ranging from 4 nm to 1 μm provide appropriate surface roughness while securing dispersibility. The nonmagnetic powder preferably has an average particle size of 5 nm to 2 μm. In this preferred range of an average particle size, the particles are satisfactorily dispersible and provide a nonmagnetic layer with appropriate surface roughness. If desired, nonmagnetic powders different in average particle size may be used in combination, or a single kind of a nonmagnetic powder having a broadened size distribution may be used to produce the same effect. A still preferred particle size of the nonmagnetic powder is 10 to 200 nm. The specific surface area of the nonmagnetic powder preferably ranges 1 to 100 m²/g, still preferably 5 to 70 m²/g, even still preferably 10 to 65 m²/g. In this preferred specific surface area range, the nonmagnetic powder provides appropriate surface roughness and is dispersible in a desired amount of a binder. The oil (DBP) absorption of the powder is preferably 5 to 100 ml/100 g, still preferably 10 to 80 ml/100 g, even still preferably 20 to 60 ml/100 g. The specific gravity of the powder is preferably 1 to 12, still preferably 3 to 6. The tap density of the powder is preferably 0.05 to 2 g/ml, still preferably 0.2 to 1.5 g/ml. Having the tap density falling within that range, the powder is easy to handle with little dusting and tends to be less liable to stick to equipment.

The nonmagnetic powder preferably has a pH of 2 to 11, still preferably between 6 and 9. With the pH ranging between 2 and 11, an increase in frictional coefficient of the magnetic recording medium experienced in a high temperature and high humidity condition or due to migration of a fatty acid can be averted. The water content of the nonmagnetic powder is preferably 0.1% to 5% by weight, still preferably 0.2% to 3% by weight, even still preferably 0.3% to 1.5% by weight. Within the preferred water content range, the powder is easy to disperse, and the resulting coating composition has a stable viscosity. The ignition loss of the powder is preferably not more than 20% by weight. The smaller the ignition loss, the better.

The inorganic nonmagnetic powder preferably has a Mohs hardness of 4 to 10 to secure durability. The nonmagnetic powder preferably has a stearic acid adsorption of 1 to 20 μmol/m², still preferably 2 to 15 μmol/m². The heat of wetting of the nonmagnetic powder with water at 25° C. is preferably 20 to 60 μJ/cm² (200 to 600 erg/m²). Solvents in which the nonmagnetic powder releases the recited heat of wetting can be used. The number of water molecules on the nonmagnetic powder at 100° to 400° C. is suitably 1 to 10 per 10 nm. The isoelectric point of the nonmagnetic powder in water is preferably pH 3 to 9.

It is preferred that the nonmagnetic powder be surface treated to have a surface layer of Al₂O₃, SiO₂, TiO₂, ZrO₂, SnO₂, Sb₂O₃, or ZnO. Among them, preferred for dispersibility are Al₂O₃, SiO₂, TiO₂, and ZrO₂, with Al₂O₃, SiO₂, and ZrO₂ being still preferred. These surface treating substances may be used either individually or in combination. According to the purpose, a composite surface layer can be formed by co-precipitation or a method comprising first applying alumina to the nonmagnetic particles and then treating with silica or vise versa. The surface layer may be porous for some purposes, but a homogeneous and dense surface layer is usually preferred.

Specific examples of commercially available nonmagnetic powders that can be used in the nonmagnetic layer include Nanotite from Showa Denko K.K.; HIT-100 and ZA-G1 from Sumitomo Chemical Co., Ltd.; DPN-250, DPN-250BX, DPN-245, DPN-270BX, DPB-550BX, and DPN-550RX from Toda Kogyo Corp.; titanium oxide series TTO-51B, TTO-55A, TTO-55B, TTO-55C, TTO-55S, and TTO-55D, SN-100, MJ-7, and α-iron oxide series E270, E271, and E300 from Ishihara Sangyo Kaisha, Ltd.; STT-4D, ST-30D, STT-30, and STT-65C from Titan Kogyo K.K.; MT-100S, MT-100T, MT-150W, MT-500B, MT-600B, T-100F, and T-500 HD from Tayca Corp.; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO2P25 from Nippon Aerosil Co., Ltd.; 100A and 500A from Ube Industries, Ltd.; and Y-LOP from Titan Kogyo K.K. and calcined products thereof. Preferred of them are titanium dioxide and α-iron oxide.

Carbon black can be incorporated into the nonmagnetic layer to reduce the surface resistivity, to decrease light transmission, and to obtain a desired micro Vickers hardness. The nonmagnetic layer generally has a micro Vickers hardness of 245 to 588 MPa (25 to 60 kg/mm²). A preferred micro Vickers hardness for good head contact is 294 to 490 MPa (30 to 50 kg/mm²). A micro Vickers hardness can be measured with a thin film hardness tester (HMA-400 supplied by NEC Corp.) having an indenter equipped with a three-sided pyramid diamond tip, 80° angle and 0.1 μm end radius. Magnetic recording tapes are generally standardized to have an absorption of not more than 3% for infrared rays of around 900 nm. For example, the absorption of VHS tapes is standardized to be not more than 0.8%. Useful carbon black species for these purposes include furnace black for rubber, thermal black for rubber, carbon black for colors, and acetylene black.

The carbon black in the nonmagnetic layer has a specific surface area of 100 to 500 m²/g, preferably 150 to 400 m²/g, an oil (DBP) absorption of 20 to 400 ml/100 g, preferably 30 to 200 ml/100 g, and an average particle size of 5 to 80 nm, preferably 10 to 50 nm, still preferably 10 to 40 nm. The carbon black preferably has a pH of 2 to 10, a water content of 0.1 to 10% by weight, and a tap density of 0.1 to 1 g/ml.

Specific examples of commercially available carbon black products for use in the nonmagnetic layer include Black Pearls 2000, 1300, 1000, 900, 800, 880, and 700, and Vulcan XC-72 from Cabot Corp.; #3050B, #3150B, #3250B, #3750B, #3950B, #950, #650B, #970B, #850B, and MA-600 from Mitsubishi Chemical Corp.; Conductex SC and RAVEN 8800, 8000, 7000, 5750, 5250, 3500, 2100, 2000, 1800, 1500, 1255, and 1250 from Columbian Carbon; and Ketjen Black EC from Akzo Nobel Chemicals.

Carbon black having been surface treated with a dispersing agent, etc., resin-grafted carbon black, or carbon black with its surface partially graphitized may be used. Carbon black may previously been dispersed in a binder before being added to a coating composition. Carbon black is used in an amount of 50% by weight or less based on the above-described inorganic powder and 40% by weight or less based on the total weight of the nonmagnetic layer. The above-recited carbon black species can be used either individually or as a combination thereof. In selecting carbon black species for use in the nonmagnetic layer, reference can be made, e.g., to Carbon Black Kyokai (ed.), Carbon Black Binran.

The nonmagnetic layer can contain organic powder according to the purpose. Useful organic powders include acrylic-styrene resin powders, benzoguanamine resin powders, melamine resin powders, and phthalocyanine pigments. Polyolefin resin powders, polyester resin powders, polyamide resin powders, polyimide resin powders, and polyethylene fluoride resin powders are also usable. Methods of preparing these resin powders are disclosed, e.g., in JP-A-62-18564 and JP-A-60-255827.

With respect to the other details of the nonmagnetic layer, that is, selection of the kinds and amounts of binder resins, lubricants, dispersants, additives, and solvents and methods of dispersing, the techniques as for the magnetic layer apply. In particular, known techniques with regard to the amounts and kinds of binder resins, additives, and dispersants to be used in a magnetic layer are useful.

The nonmagnetic layer has a thickness, e.g., of 0.2 to 3.0 μm, preferably 0.4 to 2.0 μm.

The magnetic recording medium of the invention usually has a backcoat layer on the opposite side of the nonmagnetic support with respect to the magnetic layer. The backcoat layer preferably has carbon black and inorganic powder dispersed in a binder. The formulations of the binder and the additives for the magnetic layer and the nonmagnetic layer also apply to the backcoat layer. The backcoat layer preferably has a thickness of 0.1 to 1.0 μm, still preferably 0.4 to 0.6 μm.

The nonmagnetic support that can be used in the invention can be of known materials, including biaxially stretched films of polyethylene terephthalate, polyethylene naphthalate, polyamide, polyimide, polyamide-imide, and aromatic polyamide. In particular, a nonmagnetic support made of polyethylene terephthalate, polyethylene naphthalate or polyamide is preferred. The support may be previously subjected to a surface treatment, such as a corona discharge treatment, a plasma treatment, a treatment for easy adhesion, and a heat treatment.

The nonmagnetic support preferably has a centerline average surface roughness Ra of 3 to 10 nm measured with a cut-off of 0.25 mm. The nonmagnetic support preferably has a thickness of, e.g., 1 to 50 μm, preferably 2 to 20 μm.

The magnetic recording medium of the invention may have a smoothing layer. A smoothing layer is a layer for filling the protrusions (peaks) on the surface of the nonmagnetic support which is provided between the nonmagnetic support and the magnetic layer in case where the medium has the magnetic layer formed directly on the support or between the nonmagnetic support and the nonmagnetic layer in case where the medium has the nonmagnetic layer between the support and the magnetic layer. The smoothing layer is formed by applying a radiation-curing compound on the support and curing the coating layer by irradiation. The “radiation-curing compound” is a compound that commences polymerization or crosslinking reaction on being irradiated with a radiation, such as ultraviolet rays or electron beams, and thereby cures.

The magnetic recording medium of the invention is typically produced by coating a moving nonmagnetic support with a coating composition by a wet coating technique to give a dry thickness as designed. A plurality of coating compositions, whether magnetic or nonmagnetic, may be applied successively or simultaneously. Coating equipment includes an air doctor (air knife) coater, a blade coater, a rod coater, an extrusion coater, a squeegee coater, an impregnation coater, a reverse roll coater, a transfer roll coater, a gravure coater, a kiss roll coater, a cast coater, a spray coater, and a spin coater. For the details of coating techniques, reference can be made to Saishin Coating Gijyutsu, published by Sogo Gijyutsu Center, 1983.

In the production of tape media, the ferromagnetic powder is oriented in the machine direction using cobalt magnets or a solenoid. In the case of disk media, although sufficiently isotropic orientation could sometimes be obtained without orientation using an orientation apparatus, it is preferred to use a known random orientation apparatus in which cobalt magnets are obliquely arranged in an alternate manner or an alternating magnetic field is applied with a solenoid. In using ferromagnetic metal powder, the “isotropic orientation” is preferably in-plane, two-dimensional random orientation but may be in-plane and perpendicular, three-dimensional random orientation. While hexagonal ferrite powder is liable to have in-plane and perpendicular, three-dimensional random orientation but could have in-plane two-dimensional random orientation. It is also possible to provide a disk with circumferentially isotropic magnetic characteristics by perpendicular orientation in a known manner, for example, by using facing magnets with their polarities opposite. Perpendicular orientation is particularly preferred for high density recording. Circumferential orientation may be achieved by spin coating.

It is preferred that the temperature and amount of drying air and the coating speed be adjusted to control the drying position of the coating layer. The coating speed is preferably 20 to 1000 m/min, and the drying air temperature is preferably 60° C. or higher. The coating layer may be pre-dried before entering the magnet zone.

The magnetic recording medium of the present invention is especially suited for application to magnetic recording and reproducing devices using an MR head. As previously stated, since the leakage magnetic flux from a magnetic recording medium reduces with an increasing recording density, it is necessary to use, as a reading head, an MR head capable of providing high output even from a low leakage magnetic flux. High density digital recording at a recording wavelength of 0.3 μm or shorter has been accompanied by the high error rate problem. In the present invention, the number of depressions (valleys) on the magnetic layer surface is specified taking a depth of 10 nm as a reference level. As a result, the present invention achieves reduction of spacing loss thereby to provide a magnetic recording medium with reduced dropout and a low error rate even when recorded at 0.3 μm or shorter wavelengths. Accordingly, the information recorded on the magnetic recording medium of the invention at 0.3 μm or shorter wavelengths can be reproduced satisfactorily by use of an MR head.

### EXAMPLES

The present invention will now be illustrated in greater detail with reference to Examples, but it should be understood that the invention is not construed as being limited thereto. Unless otherwise noted, all the parts and percents are by weight.

### Example 1

(1) Preparation of Polyurethane Resin

In a container equipped with a reflux condenser and a stirrer and having been purged with nitrogen, the polyol and the short chain diol shown in Table 1 below were dissolved in a 30% cyclohexanone solution at 60° C. in a nitrogen stream. Dibutyltin dilaurate was added to the solution as a catalyst to a concentration of 60 ppm, followed by stirring for 15 minutes for dissolving. The diisocyanate shown in Table 1 was further added to the reaction system, and the mixture was heated at 90° C. for 6 hours to obtain a polyurethane resin solution (designated solutions A to E). The polystyrene-equivalent weight average molecular weight of the resulting polyurethanes, measured in a dimethylformamide solution, are shown in Table 1.

TABLE 1

| | | | | | | | | Bridged |
|---|---|---|---|---|---|---|---|---|
| | Starting Materials | | | | | | | Hydrocarbon |
| | Polyol | | Short Chain Diol | | Diisocyanate | | Weight | or Spiro |
| | Component | | Component | | Component | | Average | Structure |
| Polyurethane | | Amount | | Amount | | Amount | Molecular | Content |
| Resin Solution | Kind | (wt %) | Kind | (wt %) | Kind | (wt %) | Weight | (mmol/g) |
| A | polyester | 65.4 | compound A | 3.7 | compound E | 28.8 | 72000 | 2.5 |
| | polyol A | | compound D | 2.1 | | | | |
| B | — | — | compound B | 42.7 | compound E | 53.4 | 83000 | 2.2 |
| | | | compound D | 3.9 | | | | |
| C | polyester | 72.3 | compound A | 0.0 | compound F | 25.4 | 71000 | 1.2 |
| | polyol B | | compound D | 2.2 | | | | |
| D | polyester | 68.6 | compound A | 0.0 | compound E | 29.3 | 78000 | 0.0 |
| | polyol B | | compound D | 2.1 | | | | |
| E | — | — | compound C | 47.7 | compound E | 48.7 | 80000 | 0.0 |
| | | | compound D | 3.5 | | | | |

The components shown in Table 1 above are as follows.
Polyester polyol A: adipic acid/tricyclodecanedimethanol (2/3 by mole) (molecular weight: 794)
Polyester polyol B: adipic acid/3-methyl-1,5-pentanediol (2/3 by mole) (molecular weight: 574)
   Compound A: neopentyl glycol 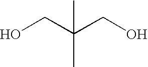
   Compound B: tricyclodecanedimethanol 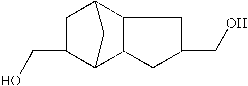
   Compound C: hydrogenated bisphenol A 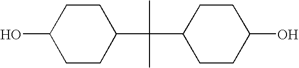
   Compound D: ethylene oxide adduct of sodium sulfoisophthalate (molecular weight: 356) 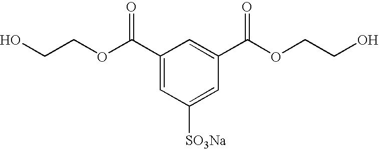
   Compound E: 4,4′-diphenylmethane diisocyanate 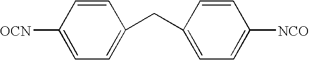
   Compound F: norbornane diisocyanate

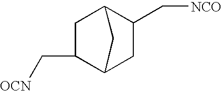

(2) Preparation of Coating Compositions for Upper Magnetic Layer and Lower Nonmagnetic Layer

| | | |
|---|---|---|
| Ferromagnetic metal powder (Hc: 189.600 kA/m | 100 | parts |
| (2400 Oe); S_{BET}: 62 m²/g; average particle | | |
| length: 45 nm; crystallite size: 11 nm; average | | |
| acicular ratio: 5; σs: 117 A · m²/kg | | |
| (117 emu/g); pH: 9.3; Co/Fe: 25 at %; Al/Fe: 7 at %; Y/Fe: | | |
| 12 at %) | | |
| Polyurethane resin solution A (on solid basis) | 20 | parts |
| Alpha-alumina (average particle size: 0.1 μm) | 8 | parts |
| Carbon black (average particle size: 0.08 μm) | 1 | part |
| Butyl stearate | 1.5 | parts |
| Stearic acid | 0.5 | parts |
| Methyl ethyl ketone | 90 | parts |
| Cyclohexanone | 30 | parts |
| Toluene | 60 | parts |

Formulation of coating composition for lower nonmagnetic layer:

| | |
|---|---|
| Nonmagnetic powder α-Fe₂O₃ (hematite) (average particle | 80 parts |
| length: 0.15 μm; S_{BET}: 58 m²/g; average acicular ratio: | |
| 7.5) | |
| Carbon black (from Mitsubishi Chemical Corp.; average | 20 parts |
| primary particle size: 16 nm; oil (DBP) absorption: | |
| 80 ml/100 g; pH: 8.0; S_{BET}: 250 m²/g; volatile content: | |
| 1.5%) | |
| Vinyl chloride copolymer (MR-110 from Zeon Corp.; | 10 parts |
| —SO₃Na content: 5 × 10⁻⁶ eq/g; degree | |
| of polymerization: 350; epoxy group content: | |
| 3.5% in terms of monomer unit) | |
| Polyurethane resin solution A (on solid basis) | 10 parts |
| Stearic acid | 2 parts |
| Methyl ethyl ketone | 150 parts |
| Cyclohexane | 50 parts |
| Toluene | 50 parts |

The components above for each formulation were kneaded in a kneader and dispersed in a sand mill. To the dispersion of the formulation for upper magnetic layer was added 1.6 parts of sec-butyl stearate. To the dispersion of the formulation for lower nonmagnetic layer was added 3 parts of polyisocyanate (Coronate L from Nippon Polyurethane). To each of the resulting dispersions was further added 40 parts of a methyl ethyl ketone/cyclohexanone mixed solvent. Each of the resulting mixture was filtered through a filter having an average opening size of 1 μm to obtain a coating composition for upper magnetic layer and a coating composition for lower nonmagnetic layer.

(3) Preparation of Coating Composition for Backcoat Layer Formulation of Coating Composition for Backcoat Layer:

| | |
|---|---|
| Fine carbon black (average particle size: 20 nm) | 100 parts |
| Coarse carbon black (average particle size: 270 nm) | 10 parts |
| Nitrocellulose resin | 100 parts |
| Polyester polyurethane resin | 30 parts |
| Dispersing agents: | |
| Copper oleate | 10 parts |
| Copper phthalocyanine | 10 parts |
| Barium sulfate (precipitate) | 5 parts |
| Methyl ethyl ketone | 500 parts |
| Toluene | 500 parts |
| Alpha-alumina (average particle size: 0.13 μm) | 0.5 parts |

The above components were kneaded in a continuous kneader and dispersed in a sand mill for 2 hours. To the resulting dispersion were added 40 parts of polyisocyanate (Coronate L from Nippon Polyurethane) and 1000 parts of methyl ethyl ketone, and the mixture was filtered through a filter having an average opening size of 1 μm to prepare a coating composition for backcoat layer.

(4) Preparation of Magnetic Tape

The coating composition for lower nonmagnetic layer and the coating composition for upper magnetic layer were simultaneously applied to a 6 μm thick polyethylene terephthalate base film (support) to a dry thickness of 1.3 μm and 0.15 μm, respectively. While the coating layers were wet, the web was subjected to orientation treatment using cobalt magnets having a magnetic flux density of 300 mT (3000 Gauss) and a solenoid having a magnetic flux density of 150 mT (1500 Gauss), followed by drying to form a lower nonmagnetic layer and an upper magnetic layer.

The coating composition for backcoat layer was applied to the opposite side of the base film to a dry thickness of 0.5 μm and dried to form a backcoat layer.

The resulting coated web in roll form was calendered on a 7-roll calender composed of heated metal rolls and thermosetting resin-covered elastic rolls at a roll temperature of 90° and a running speed of 300 m/min and slit to 0.5 in. width. The tape was passed through a solenoid having a magnetic flux density of 300 mT (3000 Gauss) for demagnetization.

### Example 2 and 3 and Comparative Examples 1 and 2

A magnetic recording tape was prepared in the same manner as in Example 1, except for replacing polyurethane resin solution A with polyurethane resin solution B (Example 2), C (Example 3), D (Comparative Example 1) or E (Comparative Example 2).

### Comparative Example 3

A magnetic recording tape was prepared in the same manner as in Example 3, except for altering the calendering conditions.

Evaluation:

The magnetic recording tapes prepared in Examples and Comparative Examples were evaluated in accordance with the following methods. The results obtained are shown in Table 2.

(a) Depression Density on Magnetic Layer

The magnetic layer was scanned over an assessment area of 260 μm by 360 μm with a three-dimensional imaging surface structure analyzer, New View 5022 from ZyGo Corp. that operates using scanning white light interferometry. The scan length was 5 μm. Measurement was taken on 10 different assessment areas. The data were processed by HPF at a wavelength of 1.65 μm and LPF at a wavelength of 50 μm. Valleys having a depth of 10 nm or more from a mean plane of the resulting surface profile were counted for every assessment area to obtain an average. The terminology “mean plane” means a reference plane for which the volumes embraced by the 3D profile above and below the plane are equal.

(b) Dropout (DO)

Dropout measurement was made on a drum tester. Signals were recorded at a recording wavelength of 0.3 μm using a metal-in-gap (MIG) write head having a Bs of 1.5 T and reproduced using an MR head. The reproduction output was measured with a spectrum analyzer. Fifty percent drops in output (dropouts) were counted and reduced to the number of dropouts per meter. A dropout rate of 5/m or less is judged “good”.

(c) Output

Output measurement was made on a drum tester. Signals were recorded at a recording wavelength of 0.3 μm using an MIG write head having a Bs of 1.5 T and reproduced with an MR head. The reproduction output was measured with a spectrum analyzer. The output of Comparative Example 1 was taken as a standard (0 dB).

TABLE 2

| | | Depression | | |
|---|---|---|---|---|
| | Ra | Density | DO Rate | Output |
| | (nm) | (/260 × 350 μm²) | (/m) | (dB) |
| Example 1 | 1.9 | 56 | 4.2 | 1 |
| Example 2 | 2.3 | 24 | 3.6 | 0.5 |
| Example 3 | 3.0 | 65 | 4.5 | 0 |
| Comp. Example 1 | 2.8 | 83 | 6.8 | 0 |
| Comp. Example 2 | 2.2 | 105 | 8.2 | 0.5 |
| Comp. Example 3 | 4.8 | 85 | 7.0 | −1 |

It is seen from Table 2 that the magnetic recording tapes of Examples having a depression density within the range specified by the present invention have lower dropout ratios than those of Comparative Examples.

This application is based on Japanese Patent application JP 2004-288084, filed Sep. 30, 2004, the entire content of which is hereby incorporated by reference, the same as if set forth at length.

What is claimed is:

1. A magnetic recording medium comprising:
a nonmagnetic support; and
a magnetic layer containing ferromagnetic powder and a binder,
wherein the magnetic layer has on a surface thereof 80 or less depressions having a depth of 10 nm or more per 260×350 μm².

2. The magnetic recording medium according to claim 1, further comprising a nonmagnetic layer containing nonmagnetic powder and a binder between the nonmagnetic support and the magnetic layer.

3. The magnetic recording medium according to claim 1, wherein the magnetic layer has a centerline average surface roughness Ra of 4.5 nm or less.

4. The magnetic recording medium according to claim 1, wherein the magnetic layer has a centerline average surface roughness Ra of 3.0 nm or less.

5. The magnetic recording medium according to claim 1, wherein the magnetic layer has a thickness of 0.15 μm or smaller.

6. The magnetic recording medium according to claim 1, wherein the magnetic layer has a thickness of 0.03 to 0.13 μm.

7. The magnetic recording medium according to claim 1, wherein the magnetic layer has a thickness of 0.05 to 0.12 μm.

8. The magnetic recording medium according to claim 1, wherein the magnetic layer has on a surface thereof 1 to 70 depressions having a depth of 10 nm or more per 260×350 μm².

9. The magnetic recording medium according to claim 1, wherein the magnetic layer has on a surface thereof 1 to 50 depressions having a depth of 10 nm or more per 260×350 μm².

10. The magnetic recording medium according to claim 1, further comprising a backcoat layer containing carbon black and inorganic powder, so that the backcoat layer, the nonmagnetic support and the magnetic layer are provided in this order.

11. The magnetic recording medium according to claim 10, wherein the backcoat layer has a thickness of 0.1 to 1.0 μm.

12. The magnetic recording medium according to claim 1, wherein the nonmagnetic support contains polyethylene terephthalate, polyethylene naphthalate, polyamide, polyimide, polyamide-imide or aromatic polyamide.

13. The magnetic recording medium according to claim 1, further comprising a smoothing layer containing a radiation-curing compound cured by irradiation between the nonmagnetic support and the magnetic layer.

14. The magnetic recording medium according to claim 2, further comprising a smoothing layer containing a radiation-curing compound cured by irradiation between the nonmagnetic support and the nonmagnetic layer.

15. A method comprising writing and reading information with a magnetic recording medium, the magnetic recording medium comprising a nonmagnetic support and a magnetic layer containing ferromagnetic powder and a binder, wherein the magnetic recording medium is the magnetic recording medium according to claim 1, and a read head having a magneto-resistive element is used for reading the information.

16. The method according to claim 15, wherein information is recorded at a recording wavelength of 0.3 μm or shorter.
